(19) United States
(12) Patent Application Publication
(10) Pub. No.: US 2016/0324165 A1
(43) Pub. Date: Nov. 10, 2016

(54) BAKING DEVICE AND FEEDING UNIT THEREOF

(71) Applicant: Tsann Kuen (Zhangzhou) Enterprise Co., Ltd., Zhangzhou (CN)

(72) Inventors: Jiawei Li, Zhangzhou (CN); Chungho Pan, Zhanzhou (CN)

(73) Assignee: Tsann Kuen (Zhangzhou) Enterprise Co., Ltd., Zhangzhou (CN)

(21) Appl. No.: 15/146,055

(22) Filed: May 4, 2016

(30) Foreign Application Priority Data
May 8, 2015 (CN) 201510232862.1

(51) Int. Cl. A21B 5/03; F16K 21/04; F16K 31/04; A47J 37/10; F16K 31/524

(52) U.S. Cl. CPC A21B 5/03; A47J 37/105; A47J 37/108; F16K 31/52475; F16K 31/047; F16K 21/04

(57) ABSTRACT

A baking device includes a base unit, a feeding unit and a baking unit. The feeding unit is mounted on the base unit, is formed with a containing space for containing food material, and is configured to control delivery of the foodmaterial out of the containing space. The baking unit is disposed below the feeding unit, and includes a lower baking plate for receiving the food material, a first heating module for heating the lower baking plate, and a driving module configured to control the lower baking plate to rotate about an axis extending in a direction of the delivery of the food material.

### CROSS-REFERENCE TO RELATED APPLICATION

This application claims priority of Chinese Patent Application No. 201510232862.1, filed on 2015 May 8.

### FIELD

The disclosure relates to a baking device for heating food material, and a feeding unit of the baking device.

### BACKGROUND

A conventional baking device includes a heating plate for heating a food material (e.g., for making eatables such as a pancake). In use, the food material is placed manually onto the heating plate in order to be heated.

However, in cases where a plurality of serving of food material are to be baked (e.g., to make a plurality of pancakes), repeated placing actions must be performed, which may be inconvenient for a user operating the baking device. Moreover, it is relatively difficult for a user to provide the same amount of the food material in each of the placing actions.

### SUMMARY

Therefore, an object of the disclosure is to provide a baking device that can alleviate at least one of the drawbacks of the prior arts.

According to the disclosure, the baking device includes a base unit, a feeding unit and a baking unit.

The feeding unit is mounted on the base unit, and is formed with a containing space for containing food material. The feeding unit is configured to control delivery of the food material out of the containing space.

The baking unit is disposed below the feeding unit, and includes a baking plate, a heating module and a driving module.

The baking plate is for receiving the food material delivered by the feeding unit. The heating module is for heating the baking plate, and a driving module configured to control the baking plate to rotate about an axis extending in a direction of the delivery of the food material by the feeding unit.

Another object of the disclosure is to provide a feeding unit included in a baking device.

According to the disclosure, the feeding unit is to be mounted on abase unit of a baking device, and includes a container, a valve component and a driving mechanism.

The container is formed with a containing space for containing food material, and has a bottom surface that is formed with a first through hole.

The valve component is disposed on the bottom surface of the container, and is movable with respect to the bottom surface between an open position and a closed position. In the open position, the valve component uncovers the first through hole. In the closed position, the valve component covers the first through hole.

The driving mechanism is configured to drive the valve component to move from the closed position to the open position.

According to another aspect of this disclosure, there is provided a baking device that includes a base unit, a feeding unit and a baking unit.

The feeding unit includes a container, a valve component and a driving mechanism. The container is formed with a containing space for containing food material and has a bottom surface formed with a first through hole. The valve component is disposed on the bottom surface of the container, and is movable with respect to the bottom surface between an open position, where the valve component uncovers the first through hole, and a closed position, where the valve component covers the first through hole. The driving mechanism is configured to drive the valve component to move from the closed position to the open position.

The baking unit is disposed below the feeding unit for receiving the food material delivered by the feeding unit when the valve component is disposed in the open position.

### BRIEF DESCRIPTION OF THE DRAWINGS

Other features and advantages of the disclosure will become apparent in the following detailed description of the embodiments with reference to the accompanying drawings, of which:

FIG. 1 is an exploded perspective view illustrating an embodiment of a baking device according to the disclosure;

FIG. 2 is a side sectional view of the baking device;

FIG. 3 is a fragmentary sectional bottom view of the baking device, illustrating a valve component being in a closed position;

FIG. 4 is a top view of a lower base and a driving module of the baking device, illustrating operations of the driving module and a micro switch;

FIG. 5 is a block diagram illustrating some components of the baking device;

FIG. 6 is a fragmentary sectional bottom view of the baking device, illustrating the valve component being in an open position;

FIG. 7 is a flow chart illustrating an exemplary process performed by the baking device; and

FIG. 8 illustrates a process flow of an example of the exemplary process

### DETAILED DESCRIPTION

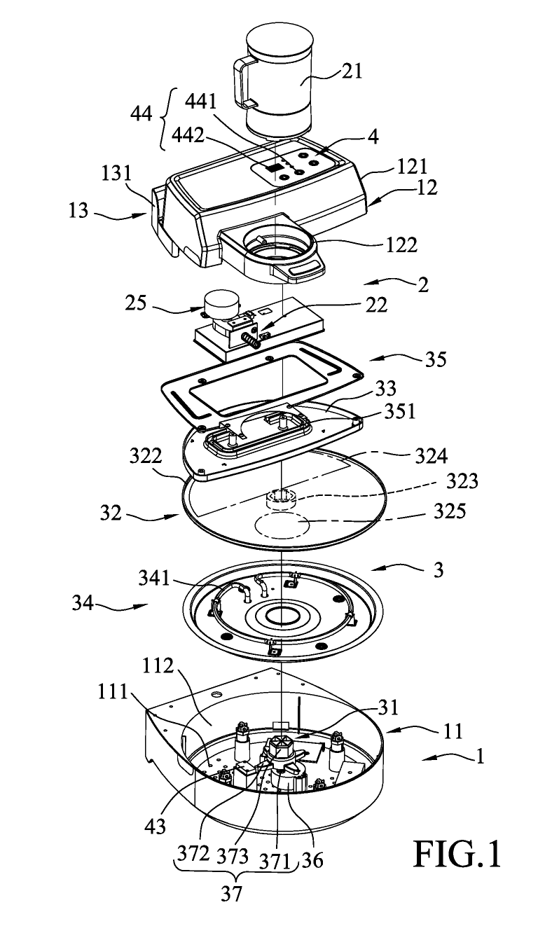

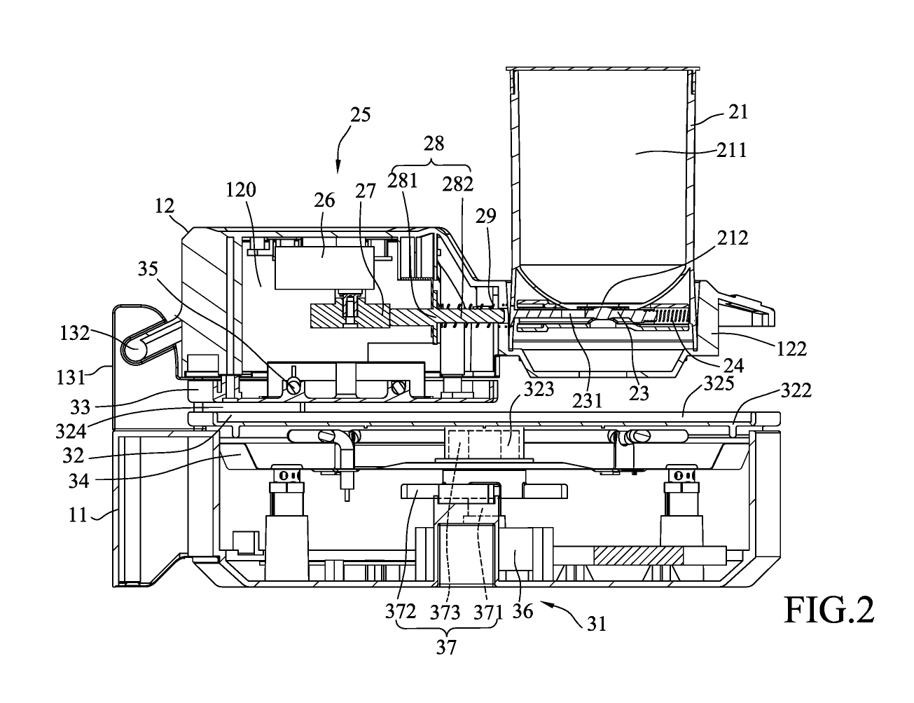

FIGS. 1 and 2 illustrate a baking device according to an embodiment of the disclosure. The baking device is for baking a food material (e.g., wheat flour, yeast powder, milk, butter, sugar, cocoa solids, water or a combination thereof). The food material may be baked to make eatables such as a pancake, a crumpet, a waffle, etc.

It should be noted herein that the directional references, such as “upward”, “downward” and the like, made throughout this disclosure are to be understood to be the ordinary directional relationships when looking directly at the figures.

The baking device includes a base unit 1, a feeding unit 2, a baking unit 3 and a control unit 4.

The base unit 1 includes a lower base 11, an upper base 12 disposed on the lower base 11, and a pivot structure 13 for pivotally and removably connecting the upper base 12 to the lower base 11.

The lower base 11 has a bottom wall 111 and a surrounding wall 112 that extends upwardly from a peripheral of the bottom wall 111. The upper base 12 includes a base body 121 and a holder 122 that extends from the base body 121. The base body 121 is formed with a mounting space 120.

In this embodiment, the pivot structure 13 is embodied using a pair of lugs 131 and a pivot rod 132. The lugs 131 extend upwardly from a rear peripheral of the base body 121, and are spaced apart from each other. The pivot rod 132 is disposed to pivotally engage the lugs 131, and allows the upper base 12 to disengage from the lower base 11.

It is noted that in other embodiments, various mechanisms may be employed by the pivot structure 13 in order to achieve a similar result.

The feeding unit 2 is mounted on the base unit 1, and includes a container 21, a valve component 23, a first spring component 24 and a driving mechanism 25.

The container 21 is formed with a containing space 211 for containing the food material, and has a bottom surface that is formed with a first through hole 212. In use, the container 21 is placed removably on the holder 122 and delivery of the food material out of the containing space 211 is controlled in a manner as described in the following.

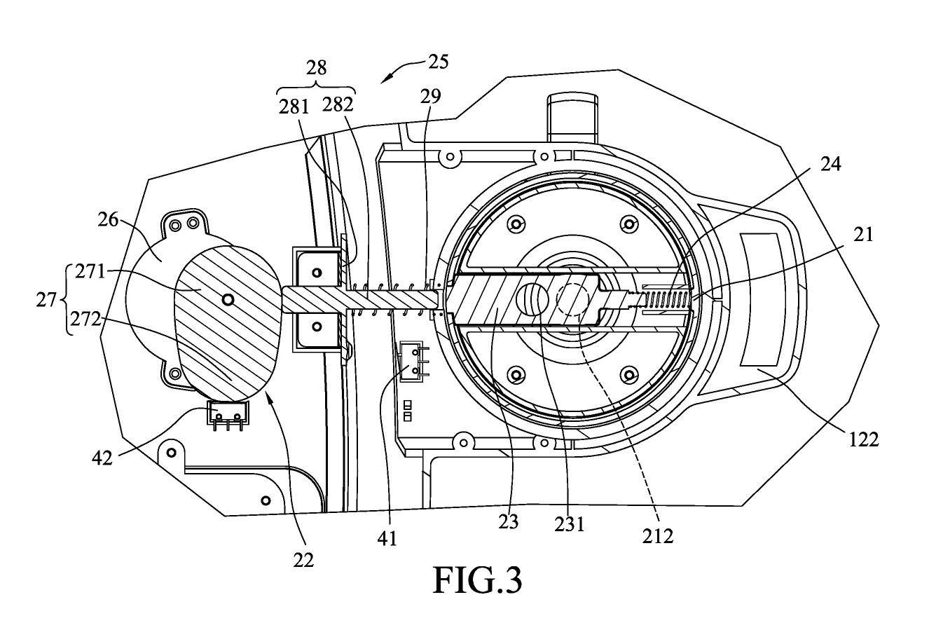

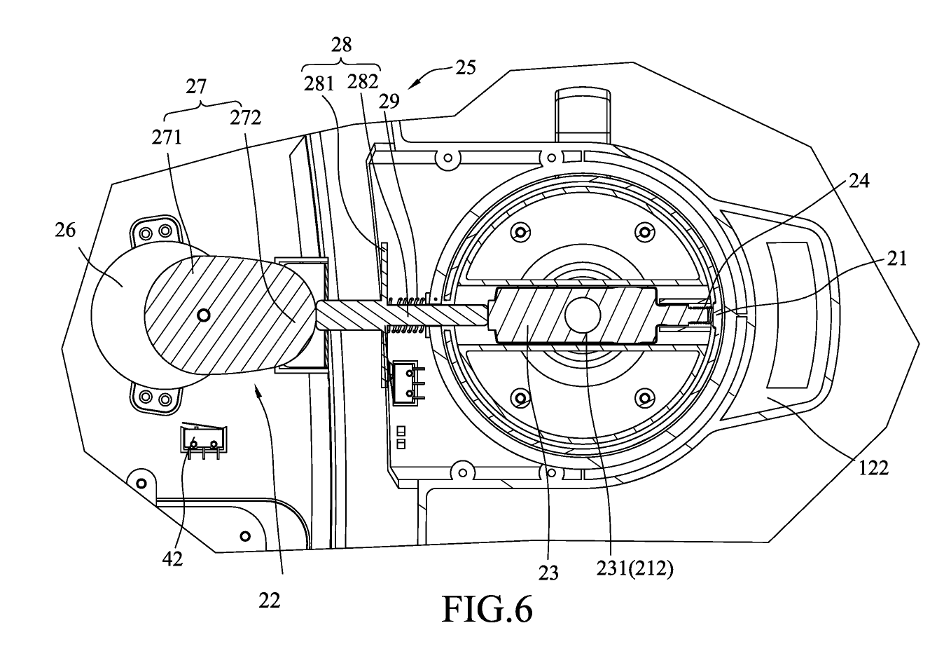

The valve component 23 is disposed on the bottom surface of the container 21, and is movable with respect to the bottom surface between an open position and a closed position. In the open position, the valve component 23 opens the first through hole 212 (see FIG. 6). In the closed position, the valve component 23 closes the first through hole 212 (see FIG. 3).

Specifically, referring to FIGS. 3 and 6, the valve component 23 is formed with a second through hole 231. When the valve component 23 is pushed to the open position, the second through hole 231 is aligned with the first through hole 212, allowing the food material to flow out from the containing space 211 (see FIG. 2).

When the valve component 23 is in the closed position, the second through hole 231 is misaligned with the first through hole 212, thereby preventing the food material from flowing out of/from the containing space 211.

The first spring component 24 is disposed adjacent to the valve component 23 for providing a first restoration force to urge the valve component 23 to move from the open position back to the closed position. Specifically, the first spring component 24 has one end abutting against the container 21, and an opposite end abutting against the valve component 23. Herein, the first spring component 24 is a compression spring. When pushed and compressed by the valve component 23, the first restoration force is generated by the first spring component 24 in a direction opposite to the direction in which the valve component 23 pushes the first spring component 24.

Referring to FIGS. 2, 3 and 6, the driving mechanism 25 is mounted in the mounting space 120 of the upper base 12, and is configured to drive the valve component 23 to move from the closed position to the open position.

Specifically, the driving mechanism 25 includes a first motor 26, a cam 27, a cam follower 28 and a second spring component 29.

The cam 27 has a base portion 271 and a cam portion 272 protruding from the base portion 271. The base portion 271 is connected to the first motor 26 and is configured to be driven by the first motor 26 to rotate. In this embodiment, the cam 27 rotates about an axis parallel to a direction of the delivery of the food material (i.e., a vertical direction).

The cam follower 28 is disposed adjacent to the valve component 23 opposite to the first spring component 24, and is configured to be pushed by rotation of the cam 27 to move relative to the holder 122, and in turn the container 21, from a releasing position to a pushing position, so as to urge the valve component 23 to move from the closed position to the open position.

Specifically, the cam follower 28 is disposed on a side of the valve component 23 opposite to the first spring component 24, and includes a board section 281 and a shaft section 282 extending from the board section 281 removably into the holder 122 for abutting against the valve component 23. The rotation of the cam 27 drives the cam portion 272 to urge the cam follower 28, which in turn pushes the valve component 23.

The second spring component 29 is sleeved on the shaft section 282, and has two opposite ends abutting against the holder 122 and the board section 281, respectively. Herein, the second spring component 29 is a compression spring. In use, the second spring component 29 is compressed to provide a second restoring force to move the cam follower 28 to the releasing position.

Specifically, when the cam 27 is rotated and the cam portion 272 is removed from the cam follower 28, the second restoration force from the second spring component 29 urges the cam follower 28 to move away from the valve component 23 and into the releasing position, and the first restoration force from the first spring component 24 urges the valve component 3 to move to the closed position. As a result, the second through hole 231 is misaligned with the first through hole 212, preventing the food material from flowing out of the containing space 211.

The baking unit 3 is disposed below the feeding unit 2, and includes a driving module 31, a lower baking plate 32, an upper baking plate 33, a first heating module 34 and a second heating module 35.

The lower baking plate 32 is disposed removably to the driving module 31 below the feeding unit 2 for receiving the food material delivered therefrom.

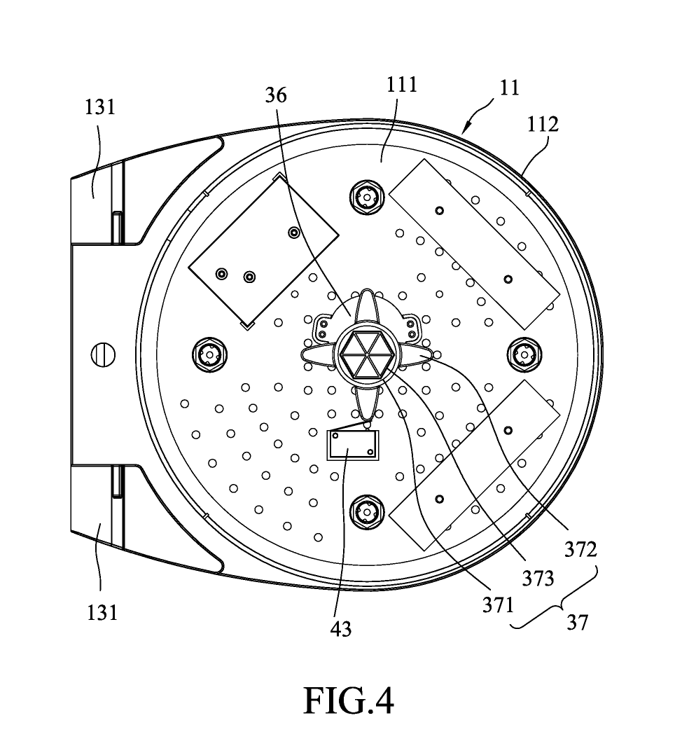

The driving module 31 is mounted on the bottom wall 111 of the lower base 11, and is configured to drive the lower baking plate 32 to rotate about a first axis extending in the direction of the delivery of the food material. Hereinafter, the axis about which the base portion 271 rotates is also referred to as a second axis. In particular, the driving module 31 includes a second motor 36 that is mounted in the lower base 11 and a rotational shaft 37 (see FIG. 4) that is driven by the second motor 36 to rotate. In this embodiment, the rotational shaft 37 includes a central axle part 371 that serves to define the first axis, four protruding parts 372, and a first engaging part 373.

The protruding parts 372 are equidistantly and angularly spaced apart from each other, and extend outwardly from the central axle part 371 in radial directions.

The first engaging part 373 is disposed at one end of the central axle part 371 for coupling with the lower baking plate 32.

The lower baking plate 32 includes a plate body 322 and a second engaging part 323. The plate body 322 in this embodiment is round-shaped, and is made from a material with high thermal conductivity. The second engaging part 323 is located at a center of a bottom surface of the plate body 322, and is shaped to be coupled removably to the first engaging part 373. As a result, the lower baking plate 32 is connected to and co-rotatable with the rotational shaft 37 about the first axis and relative to the lower base 11. In this embodiment, the first engaging part 373 is a hexagonal-prism-shaped block that protrudes upward from the plate body 322, and the second engaging part 323 is a protrusion that extends downward from the bottom surface of the plate body 322 and that is formed with a hexagonal-prism-shaped groove matching with the hexagonal-prism-shaped block. However, the configurations of the first and second engaging parts 373, 323 are not to be limited to the example given herein.

The upper baking plate 33 is substantially semicircularly shaped, and is made from a material with high thermal conductivity. The upper baking plate 33 is disposed at the upper base 12 above the lower baking plate 32 and below the base body 121, and closes the mounting space 120 of the upper base 12.

As a result, a portion of the lower baking plate 32 and the upper baking plate 33 cooperate to define a baking space 324 therebetween for heating the food material (the baking space 324 is thus semicircularly shaped), and another portion of the lower baking plate 32 and the feeding unit 2 cooperate to define a receiving space 325 between the container 21 and the lower baking plate 32 for holding the food material delivered from the feeding unit 2.

The first heating module 34 is mounted on the lower base 11 below the lower baking plate 32, and may be employed using an electrical heating tube 341. When powered by electricity, the electrical heating tube 341 is capable of generating heat for heating the lower baking plate 32.

The second heating module 35 is mounted on the upper base 12 above the upper baking plate 33, and may be employed using an electrical heating tube 351. When powered by electricity, the electrical heating tube 351 is capable of generating heat for heating the upper baking plate 33 (i.e., above the baking space 324).

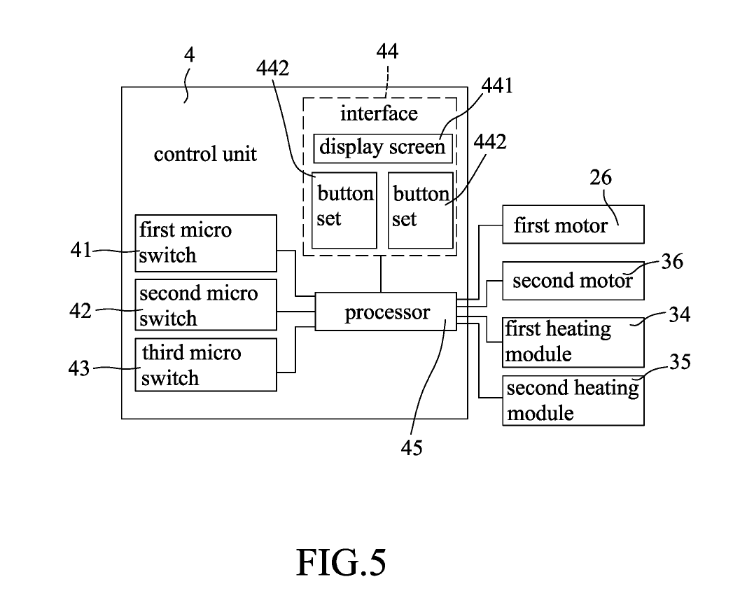

Further referring to FIG. 5, the control unit 4 is mounted on the base unit 1, and is coupled to the first motor 26, the second motor 36, the first heating module 34 and the second heating module 35 for controlling the operations thereof.

The control unit 4 includes a first micro switch 41, a second micro switch 42, a third micro switch 43, an interface 44 and a processor 45.

The first micro switch 41 is disposed to be spaced apart from the board section 281 of the cam follower 28 when the cam follower 28 is not pushed (i.e., when cam follower 28 is in the releasing position such that the valve component 23 is in the closed position).

When the cam follower 28 is pushed by the cam 27 (i.e., to move to the pushing position), the board section 281 moves toward the first micro switch 41 and triggers the same when the board section 281 comes into contact with the first micro switch 41. In response, the first micro switch 41 outputs a first control signal.

The second micro switch 42 is disposed at a side of the base portion 271 of the cam 27.

When rotation of the base portion 271 of the cam 27 about the second axis (e.g., when the cam follower 28 is in the releasing position) drives the cam portion 272 to contact the second micro switch 42 and trigger the same, the second micro switch 42 outputs a second control signal in response.

The third micro switch 43 is disposed at a side of the central axle part 371. When rotation of the rotational shaft 37 drives one of the protruding parts 372 to come into contact with the third micro switch 43, the third micro switch 43 is triggered and outputs a third control signal in response.

The interface 44 may include a display screen 441 and a button set 442. The interface 44 allows user-input of a number of baking operations, a feeding time period during which the food material is fed from the containing space 211 to the baking unit 3 (i.e., to control the amount of food material delivered), and a baking time period during which the baking space 324 is heated. In other embodiments, the interface 44 may be embodied using a touch screen.

The processor 45 is coupled to the first micro switch 41, the second micro switch 42 and the third micro switch 43, for receiving the first, second and third control signals therefrom, and is further coupled to the interface 44, the first motor 26, the second motor 36, the first heating module 34 and the second heating module 35. In use, upon receiving one of the first and second control signals, the processor 45 is programmed to stop the first motor 26. Upon receiving the third control signal, the processor 45 is programmed to stop the second motor 36.

The operation of the baking device will now be described.

When it is desired to bake the foodmaterial contained in the container 21, a user may operate the interface 44 to activate the baking device for performing a feeding process. In response, the processor 45 activates the first motor 26 for controlling the cam 27 to rotate, urging the cam follower 28 to push the valve component 23 to the open position.

Once the valve component 23 is disposed in the open position, the first and second through holes 212, 231 are aligned so that the food material starts flowing from the container 21 to the lower baking plate 32 through the first and second through holes 212, 231. Simultaneously, the first spring component 24 stores the first restoration force and the second spring component 29 stores the second restoration force, and the board section 281 of the cam follower 28 comes into contact with the first micro switch 41, and triggers the same as a result. The first micro switch 41 in turn generates the first control signal for stopping the first motor 26. The processor 45 then starts timing.

After the feeding time period (pre-set by the user using the interface 44) has elapsed, the processor 45 again activates the first motor 26 for controlling the cam 27 to rotate until the cam portion 272 thereof leaves the cam follower 28 and comes into contact with the second micro switch 42 and triggers the same to generate the second control signal, which when received by the processor 45 enables the processor 45 to stop the first motor 26. During said rotation of the cam 27, the second restoration force stored in the second spring component 29 urges the cam follower 28 to leave the valve component 23 and move to the releasing position, and the first restoration force stored in the first spring component 24 urges the valve component 23 to move to the closed position, so that the food material is prevented from flowing out from the container 21, thereby completing the feeding process.

In this embodiment, a pad made of silica gel may be disposed between the container 21 and the valve component 23 for preventing the food material from flowing into a slit between the container 21 and the valve component 23 when the valve component 23 is disposed in the closed position.

In cases multiple servings of food material are to be baked, the baking device may be controlled to perform a rotating operation.

In the rotating operation, the processor 45 activates the second motor 36 to drive the rotation of the rotational shaft 37. In this embodiment, the rotational shaft 37 rotates in a clockwise direction. In response, the lower baking plate 32 is driven to co-rotate with the rotational shaft 37.

When one of the protruding parts 372 comes into contact with and triggers the third micro switch 43 (i.e., the rotational shaft 37 has rotated by 90 degrees), the third control signal generated in response by the third micro switch 43 enables the processor 45 to stop the second motor 36. That is, in this embodiment, one rotating operation turns the lower baking plate 32 by degrees in the clockwise direction. In other embodiments, the rotational shaft 37 may rotate in a counterclockwise direction.

With the lower baking plate 32 rotated for the first time, the part of the lower baking plate 32 corresponding with the feeding unit 2 (i.e., directly below the first through hole 212 and the second through hole 231) has yet been fed with the food material, and an additional feeding operation may be performed. That is to say, in this case, the lower baking plate 32 can bake two servings of food material simultaneously after the two servings of food material are fed onto the baking space 324 once the lower baking plate 32 is rotated in the clockwise direction by another 90 degrees.

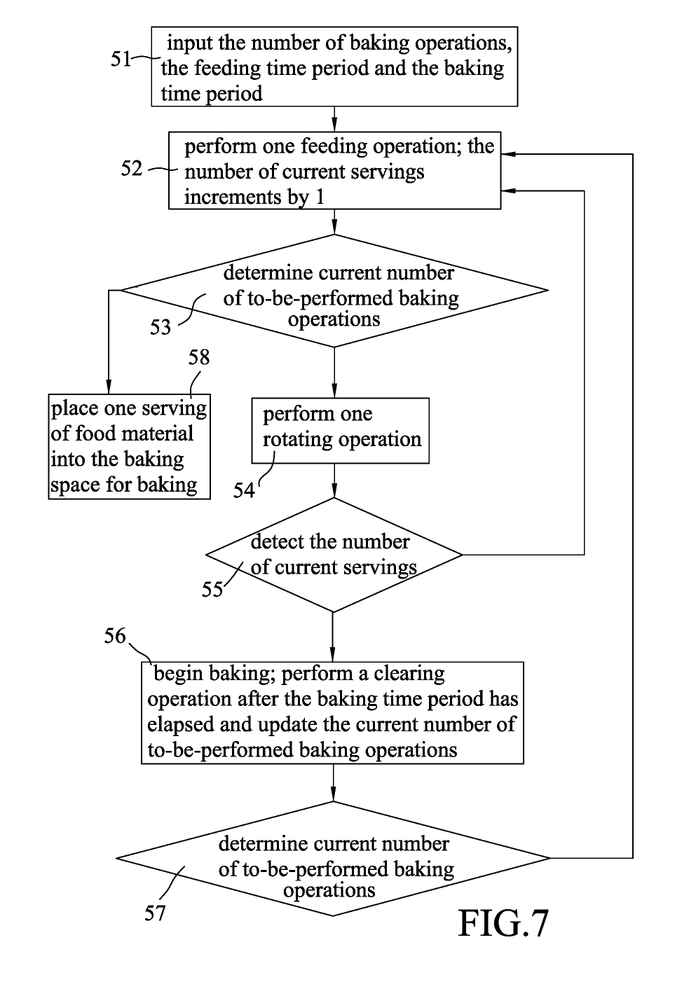

FIG. 7 illustrates steps of a method for operating the baking device to bake of the food material.

In step 51, the user of the baking device inputs the number of baking operations (i.e., the number of servings of the foodmaterial to be baked), the feeding time period and the baking time period. In this embodiment, the number of baking operations is 4, the feeding time period is 5 seconds, and the baking time period is 150 seconds.

The processor 45 further stores a number of current servings of the food material on the lower baking plate 32, and a current number of to-be-performed baking operations. In the beginning, the number of current servings is 0, and the current number of to-be-performed baking operations equals the number of baking operations inputted by the user through the interface 44, i.e., 4. Moreover, the first heating module 34 and the second heating module 35 are powered on for pre-heating the lower baking plate 32 and the upper baking plate 33.

In step 52, after the lower baking plate 32 and the upper baking plate 33 reach a temperature adequate for baking the food material, the processor 45 controls the components of the baking device to perform one feeding operation.

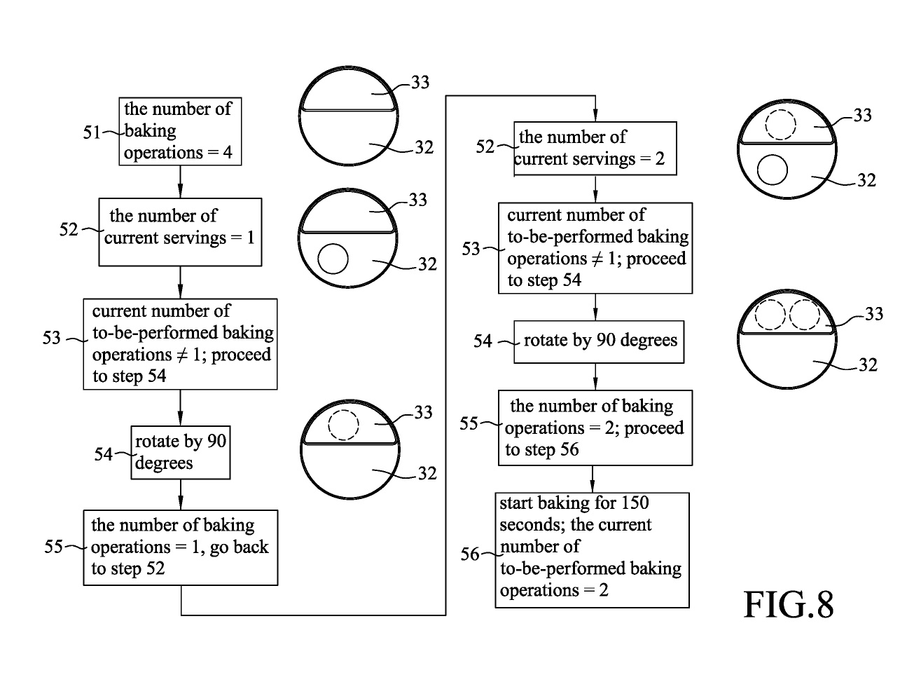

The feeding operation results in one serving of the food material (of 5 seconds worth) being fed onto the lower baking plate 32, as seen in FIG. 8. The number of current servings increments by 1.

Afterward, in step 53, the processor 45 determines how many serving(s) of the food material is yet to be baked (i.e., a remaining number of baking operations as indicated by the current number of to-be-performed baking operations). When the number equals 1, the flow proceeds to step 58. Otherwise, the flow proceeds to step 54. In this case, since the current number of to-be-performed baking operations is 4, the flow proceeds to step 54.

In step 54, the processor 45 drives the driving module 31 to perform one rotating operation, in which the lower baking plate 32 rotates with respect to the upper baking plate 33 by 90 degrees in the clockwise direction. The food material fed onto the lower baking plate 32 in step 52 is thus moved under the upper baking plate 33 (i.e., from the receiving space 325 to the baking space 324) for baking.

In step 55, the processor 45 determines how many serving(s) of food material is currently on the lower baking plate 32 (i.e., the number of current servings). When it is determined that the number of current servings does not equal to 2, the flow goes back to step 52 for repeating steps 52 to 55 until it is determined that two servings of food material are in the baking space 324 for baking. Afterward, the step proceeds to step 56.

In step 56, the baking of the two servings of food material commences, and the processor 45 begins timing for determining whether the baking time period has elapsed. After the baking time period has elapsed, the processor 45 controls the baking unit 3 to perform a clearing operation, in which the two servings of (baked) food material are removed from the baking space 324. This may be done by controlling the lower baking plate 32 to rotate by 180 degrees such that the two servings of baked food material can be removed by the user. Alternatively, the baking unit 3 may further include a sweeping board (not depicted in the drawings) for automatically removing the baked food material. Afterward, the processor 45 decrements the current number of to-be-performed baking operations by the number of current servings (i.e., changed to 2). In step 57, the processor 45 detects the current number of to-be-performed baking operations. In the case that the current number of to-be-performed baking operations is 0, the method is terminated as no more food material needs to be baked. In the case that the current number of to-be-performed baking operations is greater than 0 (for example, 2 in this case), the flow goes back to step 52 to perform more baking operations until the current number of to-be-performed baking operations becomes 0.

In another example, when the current number of to-be-performed baking operations detected in step 57 is 1, the flow proceeds to step 52 for performing one feeding operation. As described above, the flow proceeds to step 53, and subsequently proceeds to step 58.

In step 58, the processor 45 controls the lower baking plate 32 to rotate by 180 degrees for placing the one serving of food material into the baking space 324, and waits for the baking time period to elapse in order to produce the baked food material, before terminating the method.

To sum up, the baking device as disclosed by the disclosure employs the feeding unit 2 and the control unit 4 in order to automatically provide servings of the food material with the same amount, and to control the food material to be baked for a precisely calculated baking time period. Additionally, the lower baking plate 32 is made in a round shape, such that the rotation thereof occupies less space (e.g., relative to plates of other shapes).

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A baking device comprising:
a base unit;
a feeding unit mounted on said base unit, formed with a containing space for containing food material, and configured to control delivery of the food material out of said containing space; and
a baking unit disposed below said feeding unit, and including
a lower baking plate for receiving the food material delivered by said feeding unit,
a first heating module for heating said lower baking plate, and
a driving module configured to control said lower baking plate to rotate about an axis extending in a direction of the delivery of the food material.

2. The baking device of claim 1, wherein said base unit includes:
a lower base having said driving module, said first heating module and said lower baking plate mounted thereon; and
an upper base pivotally connected to and disposed on said lower base, and having said feeding unit mounted thereon.

3. The baking device of claim 2, wherein said baking unit further includes an upper baking plate disposed on said upper base above said lower baking plate, and a second heating module for heating said upper baking plate;
wherein a portion of said lower baking plate and said upper baking plate cooperate to define a baking space therebetween for heating the food material, and another portion of said lower baking plate and said feeding unit cooperate to define a receiving space for holding the food material from said feeding unit.

4. The baking device of claim 3, wherein said driving module is configured to control said lower baking plate to rotate with respect to said upper baking plate for moving the food material from said receiving space to said baking space.

5. The baking device of claim 1, wherein said feeding unit includes:
a container formed with said containing space, and having a bottom surface that is formed with a first through hole;
a valve component disposed on said bottom surface of said container, and movable with respect to said bottom surface between an open position, where said valve component uncovers said first through hole, and a closed position, where said valve component covers said first through hole;
a driving mechanism configured to drive said valve component to move from the closed position to the open position; and
a first spring component disposed adjacent to said valve component for providing a first restoration force to push said valve component from the open position to the closed position.

6. The baking device of claim 5, wherein said driving mechanism includes:
a first motor;
a cam that is driven by said first motor to rotate;
a cam follower that is disposed adjacent to said valve component opposite to said first spring component, and that is configured to be pushed by rotation of said cam to move from a releasing position to a pushing position so as to urge said valve component to move from the closed position to the open position; and
a second spring component that is configured to provide a second restoring force to said cam follower when said cam follower is pushed by said cam.

7. The baking device of claim 6, wherein said valve component is formed with a second through hole, and said cam has a cam portion;
wherein, when said cam is rotated to push said cam follower by said cam portion to move to the pushing position, said valve component is pushed by said cam follower to the open position, and said second through hole is aligned with said first through hole, allowing the food material to flow out of said containing space;
wherein, when said cam is rotated and said cam portion leaves said cam follower, the second restoration force from said second spring component moves said cam follower away from said valve component and into the releasing position, and the first restoration force from said first spring component moves said valve component into the closed position, and said second through hole is misaligned with said first through hole, preventing the food material from flowing out of said containing space.

8. The baking device of claim 7, further comprising a control unit for controlling operations of said feeding module and said driving module.

9. The baking device of claim 8, wherein said control unit includes:
a first micro switch that is configured to be triggered by said cam follower to output a first control signal when said cam follower is in the pushing position;
a second micro switch that is configured to be triggered by said cam portion of said cam to output a second control signal when said cam is rotated such that said cam follower is in the releasing position; and
a processor that is coupled to said first and second micro switches, and that is programmed to stop said first motor upon receipt of one of the first and second control signals.

10. The baking device of claim 8, wherein said driving module includes a second motor, and a rotational shaft configured to be driven by said second motor to rotate and including four protruding parts that are equidistantly and angularly spaced apart from one another and that extend outwardly in radial directions from said rotational shaft,
wherein said control unit includes a micro switch configured to be triggered by one of said protruding parts to output a control signal during rotation of said rotational shaft, and a processor coupled to said micro switch and programmed to stop said second motor upon receipt of the control signal,
wherein said lower baking plate is connected to and co-rotatable with said rotational shaft.

11. The baking device of claim 8, wherein said control unit includes an interface that allows user-input of a number of baking operations, a feeding time period during which the food material is fed from said containing space, and a baking time period during which said baking space is heated.

12. A feeding unit that is to be mounted on a base unit of a baking device, said feeding unit comprising:
a container formed with a containing space for containing food material, and having a bottom surface that is formed with a first through hole;
a valve component disposed on said bottom surface of said container, and movable with respect to said bottom surface between an open position, where said valve component uncovers said first through hole, and a closed position, where said valve component covers said first through hole; and
a driving mechanism configured to drive said valve component to move from the closed position to the open position.

13. The feeding unit of claim 12, wherein said driving mechanism includes:
a first motor;
a cam that is driven by said first motor to rotate; and
a cam follower that is disposed adjacent to said valve component opposite to said first spring component, and that is configured to be pushed by rotation of said cam to move from a releasing position to a pushing position so as to urge said valve component to move from the closed position to the open position.

14. The feeding unit of claim 13, further comprising a first spring component disposed adjacent to said valve component for providing a first restoration force to push said valve component from the open position to the closed position.

15. The feeding unit of claim 14, further comprising a second spring component that is configured to provide a second restoring force to said cam follower when said cam follower is pushed by said cam.

16. The feeding unit of claim 15, wherein said valve component is formed with a second through hole, and said cam has a cam portion;
wherein, when said cam is rotated to push said cam follower by said cam portion to move to the pushing position, said valve component is pushed by said cam follower to the open position, and said second through hole is aligned with said first through hole, allowing the food material to flow out from said containing space;
wherein, when said cam is rotated and said cam portion leaves said cam follower, the second restoration force from said second spring component move said cam follower away from said valve component and into the releasing position, the first restoration force from said first spring component moves said valve component into the closed position, and said second through hole is misaligned with the first through hole, preventing the food material from flowing out of said containing space.

17. A baking device comprising:
a base unit;
a feeding unit including
a container that is formed with a containing space for containing foodmaterial and that has a bottom surface formed with a first through hole,
a valve component that is disposed on said bottom surface of said container, and that is movable with respect to said bottom surface between an open position, where said valve component uncovers said first through hole, and a closed position, where said valve component covers said first through hole, and
a driving mechanism that is configured to drive said valve component to move from the closed position to the open position; and
a baking unit disposed below said feeding unit for receiving the food material delivered by said feeding unit when said valve component is in the open position.

18. The baking device of claim 17, wherein said baking unit includes
a lower baking plate for receiving the food material delivered from said feeding unit,
a first heating module for heating said lower baking plate, and
a driving module configured to control said lower baking plate to rotate about an axis extending in a direction of the delivery of the food material.

19. The baking device of claim 18, wherein said baking unit further includes an upper baking plate disposed on said upper base above said lower baking plate, and a second heating module for heating said upper baking plate;
wherein a portion of said lower baking plate and said upper baking plate cooperate to define a baking space therebetween for heating the food material, and another portion of said lower baking plate and said feeding unit cooperate to define a receiving space for holding the food material from said feeding unit.

20. The baking device of claim 19, wherein said driving module is configured to control said lower baking plate to rotate with respect to said upper baking plate for moving the food material from said receiving space to said baking space.
